(19) United States
(12) Patent Application Publication
(10) Pub. No.: US 2012/0261353 A1
(43) Pub. Date: Oct. 18, 2012

(54) SEPARATOR

(76) Inventor: Donald Ian Phillips, Balnarring Beach (AU)

(21) Appl. No.: 13/497,393

(22) PCT Filed: Sep. 10, 2010
(86) PCT No.: PCT/AU2010/001180

§ 371 Date: Jun. 29, 2012

(30) Foreign Application Priority Data
Sep. 22, 2009 (AU) 2009904585

(51) Int. Cl. E03F 1/00; C02F 1/00

(52) U.S. Cl. 210/747.1; 210/170.01

(57) ABSTRACT

A solids separator for use in a sewer overflow chamber having an inlet, flow chamber and main outlet, whereby liquid, having solids entrained therein, flows from the inlet through the flow chamber to the outlet, the solids separator comprising: an overflow weir over which liquid flows during overflow into a separation chamber; a filter in the separation chamber that filters solids and allows liquid to pass through to an overflow outlet; and a return outlet through which filtered solids return back into the flow chamber, wherein the filter includes an array of vertical filter members spaced from a top of the overflow weir such that a liquid flowing over the weir passes through the filter members.

The present invention relates to a separator for separating solids from a liquid flow.

### BACKGROUND

In older sewerage systems in Europe, Asia and North and South America, both sewage and stormwater are conveyed in the same pipe to a sewerage treatment plant. These systems work well until the combined sewage and stormwater flow exceeds the capacity of the sewerage system and the excess flow is discharged by way of overflow chambers to local waterways such as rivers, streams, lakes and the sea and solids escape the sewage system with the excess flow.

Escaping solids can also occur where the sewerage and stormwater systems are separate and the sewerage system is old and cannot cope with a high infiltration of rainwater during storms.

Uncontrolled sewage discharges can have serious environmental, public health and aesthetic consequences. Solids separators, such as that disclosed in Applicant's patent application WO2008/052261, have been developed in a bid to remove objectionable matter from overflowing sewage before it discharges to local water bodies. The separator disclosed in that document is independent of external power sources and a perforated screen is used to filter solid bodies from the sewer overflow whereby the bodies are detained and, after the sewer flow recedes, returned to the sewer for conveyance to the sewerage treatment plant.

In practice the perforated screen of the above disclosure has proven unsatisfactory as it is highly susceptible to blockage and therefore requires excessive maintenance. Consequently there is required a solids separator for use in a combined sewer overflow chamber that addresses the problems encountered by previous separators.

### BRIEF DESCRIPTION OF THE DRAWINGS

An embodiment, incorporating all aspects of the invention, will now be described by way of example only with reference to the accompanying drawings in which:

FIG. 1 is a plan view of a solids separator in accordance with an embodiment of the present invention;

FIG. 2 is a side view of the solids separator taken at section A-A of FIG. 1 and illustrating dry weather flow;

FIG. 3 shows a similar side view as FIG. 2 with water level rising;

FIG. 4 shows a similar side view as FIG. 3 during overflow;

FIG. 5 shows a similar side view as FIG. 4 with water levels receding back to dry weather flow;

FIG. 6 is a front view of the solids separator taken at section C-C of FIG. 1; and

FIG. 7 is a side section view taken at section B-B of FIG. 1 illustrating the ball valve.

### DETAILED DESCRIPTION ON EMBODIMENT

The solids separator 10 illustrated in the drawings is for use in a combined sewer overflow (flow) chamber 12 where the chamber 12 has an inlet 13 and a main outlet 14 whereby liquid, namely water, having solids entrained therein, flows from the inlet 13 through the chamber 12 and to the outlet 14. The separator is also suitable for use in separate overflow systems.

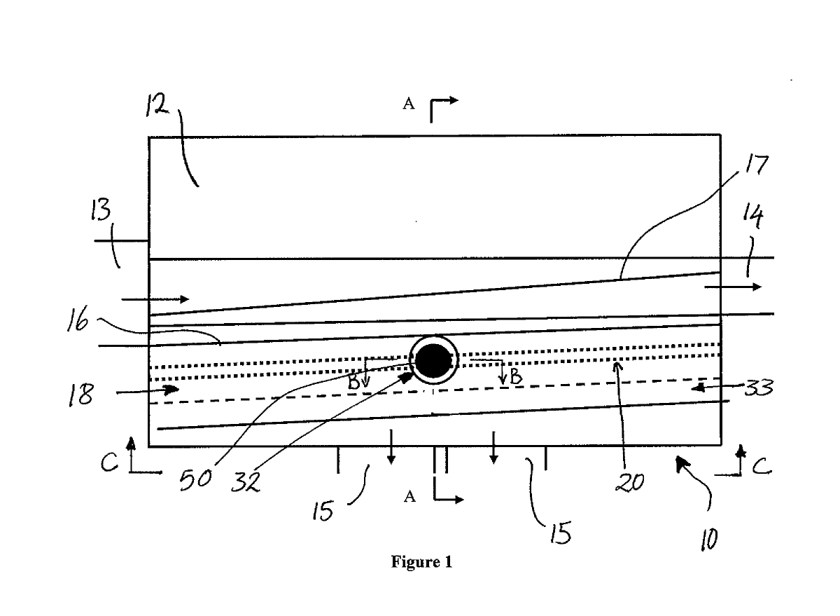

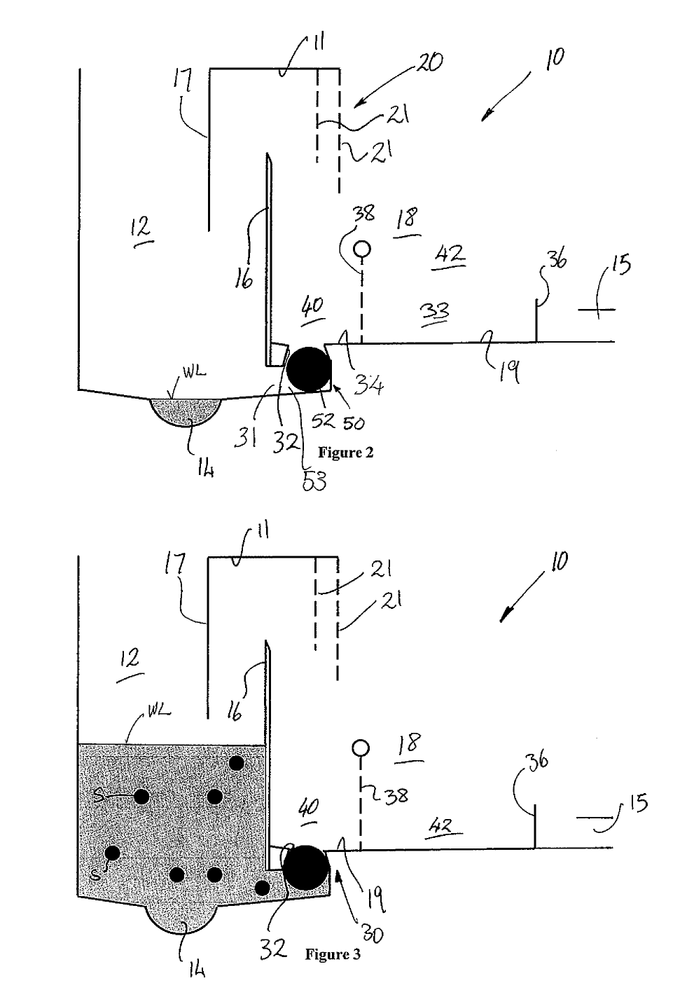

During large flows, liquid in the overflow chamber flows over a sharp-crested overflow weir 16 and into a separation chamber 18. As illustrated in FIGS. 1 and 2, a filter 20 in the separation chamber 18 filters solids from the overflowing liquid allowing liquid to pass through the filter to an overflow outlet 15 but retaining solids to be flushed back through a return channel 31 to the overflow chamber.

A damper, in the form of a baffle wall 17, is spaced from the overflow weir 16 for dampening turbulent flow entering the separation chamber from the overflow chamber. The baffle wall hangs downwardly from a ceiling 11 of the overflow chamber and is located higher than the weir but with the bottom of the baffle wall located lower than the top of the weir.

The baffle wall is spaced from the weir at a distance equal to or less than the size of a return outlet 32 in the return system so as to prevent solids that could become stuck in the return system from entering the separation chamber.

The filter 20 is designed to filter solids out of the overflowing water rather than to filter the water flow from the solids. The filter consists of one or more arrays 21 of vertically oriented members 22 that hang downwards, namely are suspended, immediately downstream of the sharp-crested weir 16. The drawings illustrate the separator comprising two filter arrays 21, though it is understood that the system may comprise only one array, or three, four or more arrays, depending on the extent of filtering required and/or on the distance separating the vertical members 22. The vertical members 22 are attached by top ends to the ceiling 11, or the like, of the overflow chamber and extend down into the separation chamber 18 to terminate spaced above a floor 19 of the separation chamber and below the top of the weir 16.

The filter arrays 21 extend across the full width of the separator and in one embodiment the vertical members 22 are wires or rods that form a comb-like filter array across the separator. Therefore the ‘nappe’, which is the profile of the liquid flowing over the weir in a vertical drop, freely flows through the array of vertically inclined wires, or combs, which intercept or comb out the entrained sewer solids as shown in FIG. 4. On passing through the wire combs the nappe falls to impact on the water surface of a filtered water (flush) chamber 42 before exiting the separator via the overflow outlet 15. The intercepted sewer solids are washed down and off the wire arrays and held in a holding chamber 40 pending their later return to the sewer once the water level in the overflow chamber drops to normal, or dry weather, flow.

The wire comb members 22 are preferably round or oval in cross section to minimise interference with the nappe, but can function suitably as square cross sectioned members. The members 22 are sufficiently rigid to withstand undesirable bending under the forces of flowing liquid. Suitable materials for forming the members include, but are not limited to, stainless steel, galvanised steel, spring steel, plastics, fibre glass or carbon fibre. The members are typically between 1 mm and 5 mm in diameter, and preferably around 3 mm in diameter.

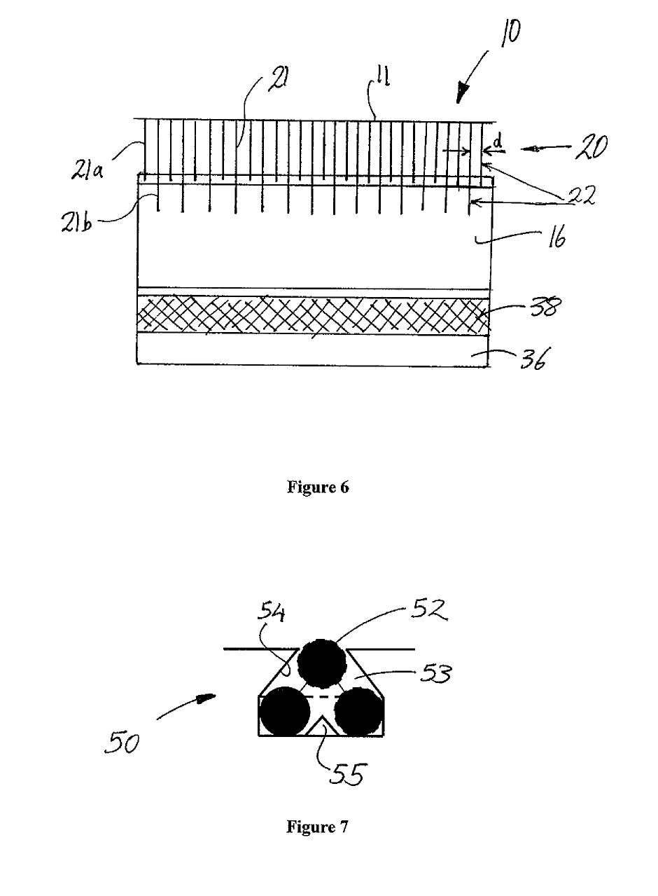

The distance d separating each member, measured centre to centre as shown in FIG. 6, should be sufficient to effectively remove the smallest solids from an overflow, which it is generally agreed are cigarette butts having a minimum 6 mm×6 mm area profile. In a solids separator 10 using a single array of comb members 22, a distance d of between 5 mm to 25 mm is effective in removing most, if not all, solids from an overflow.

However, an even smaller separation distance d can be achieved, and/or a more effective filtering process obtained, by using more than one array of members, namely multiple combs of wires placed one behind the other in staggered formation in the liquid flow path.

The Figures illustrate two arrays 21 of filter members 22 spaced apart downstream from each other and staggered (see FIG. 6) so that a member from one array is aligned centrally within the space between two members of the other array.

Using two arrays has the result of reducing the effective spacing between members by half. For example, if the spacing between 3 mm diameter filter members in each array is 25 mm, and there are two arrays aligned in a staggered relationship, the effective space measured in a straight line between two staggered members (one from each array) through which an overflowing solid can pass is 9.5 mm. Aligning three arrays of the filter members reduces the effective spacing even further, to nearly 5 mm in the above example, and/or allows for greater spacing between filter members in each array. The more arrays that are used the further distance d can be reduced and consequently a finer filtering process.

A liquid return system 30 containing a one way valve flushes the filtered solids back to the overflow chamber when the flow level in the overflow chamber has receded, and has a holding means for holding a sufficient amount of filtered water to flush the filtered solids.

The holding means in the liquid return system 30 is preferably an open holding trough 33 having a floor 34 that is inclined towards the return outlet 32 in which is located a one-way ball valve 50. The holding trough extends the width of the separator and has one rear low wall in the form of an exit weir 36 for allowing filtered water to overflow trough 33 and escape through to the overflow outlet 15. The water exiting through overflow outlet 15 is therefore filtered and clean of sewer solids.

Between the exit weir 36 of the overflow trough and the ball valve is a retention screen 38 extending the length of the trough and is upright from the trough floor 34. Retention screen 38 divides the trough into the holding chamber 40 for retaining the filtered solids on the side of ball valve 50, and the flush-water (or filtered water) chamber 42 that holds filtered water in reserve for flushing filtered solids back through the ball valve into the overflow chamber. The retention screen 38 may be a perforated screen, a mesh screen, a bar screen, may be made of an array of wires or other suitable structure for retaining solids while allowing water to pass through. The trough may also be segmented along its width in the filtered water, or flush-water, chamber 42 to direct maximum flow of reserved water back into the holding chamber 40.

A lower section of the retention screen, for a predetermined distance to either side of the ball valve, may be solid to prevent the passage of water therethrough and rather directs the last of the draining water from the filtered liquid chamber 42 to pass through the ends of the retention screen and hence better flush the solids from the holding chamber 40. In such an arrangement a segmented trough is not necessary.

In another embodiment the retention screen 38 tilts from its base towards the overflow weir 16 to ensure that low overflows cascade over the screen while still providing room at its base to accommodate a large ball valve. Additionally, the top of the retention screen may be higher than the bottom of the depending filter members, to close the gap between the screen and filter members to prevent escape of solids from the holding chamber during large flows where high backwater may occur.

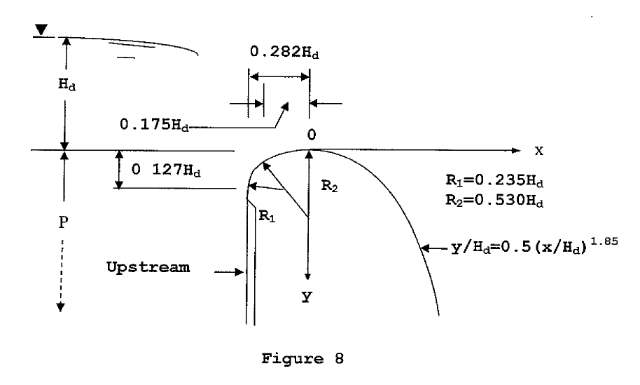

The ball valve 50 in the embodiment illustrated, particularly in FIG. 7, comprises a floating ball 52 captured in a valve chamber 53. The chamber ceiling 54 is inclined upwards towards the return outlet 32 located at an apex of the ceiling. A pointed stop 55 on the floor of the valve chamber 53 directs the ball to one side or another of the chamber as the ball lowers, thereby preventing the ball from obstructing the return outlet 32 and the return channel 31.

To determine the dimensions of the solids separator 10 and the respective positioning of its components, and particularly the spacing of the filter arrays from the weir and from each other (if applicable), calculations can be carried out using equations relating to the curve profile of the underside of an overflowing nappe. One such equation is as follows with reference to FIG. 8. (Ref: R. E. Featherstone and C. Nalluri; Civil Engineering Hydraulics, 3^{rd} Ed., pps 68-69 for the Ogee weir profile.):

y/H_{d}=0.5(x/H_{d})^{1.85} Equation 1:

where x and y are coordinates of the underside of a nappe profile with respect to the crest of the sharp crested weir 16, and H_{d} is the design head over the highest point of the nappe underside.

In practice, and economically, it is desired to make the design head as small as possible but sufficiently large to avoid negative pressures on the crest that could cause cavitation or structural vibrations.

Applied to a sharp-crested weir and evaluated for a particular overflow, Equation 1 can be used to calculate specific x,y coordinates to plot the profile of the underside of the nappe at that particular overflow rate. For example, for a maximum once-per-year overflow “Q₁” of 0.07 m3/m/s, being the overflow per metre length of weir, Equation 1 can be evaluated to calculate the coordinates of the profile of the underside of the nappe at that once-a-year overflow with respect to the apogee of the nappe underside, namely the crest of the nappe underside. At Q₁=0.07 m3/m/s, the design head H_{d}=0.1 metres. The resulting x,y coordinates with respect to the apogee are shown in table 1 below.

TABLE 1
Coordinates for Q₁ with respect to the
apogee of underside of the nappe

| x(m) | y(m) |
|---|---|
| 0.145 | 0.10 |
| 0.211 | 0.20 |
| 0.263 | 0.30 |
| 0.307 | 0.40 |
| 0.347 | 0.50 |
| 0.383 | 0.60 |
| 0.416 | 0.70 |

From Table 1 and FIG. 8, the remaining dimensions in FIG. 8 can be calculated to thereby establish the coordinates of the nappe underside with respect to the crest of the sharp-crested weir. These coordinates are shown in Table 2.

TABLE 2
Nappe underside coordinates with respect
to the sharp-crested weir for Q₁

| X(m) | Y(m) |
|---|---|
| 0.173 | 0.087 |
| 0.239 | 0.187 |
| 0.291 | 0.287 |
| 0.335 | 0.387 |
| 0.375 | 0.487 |
| 0.411 | 0.587 |
| 0.444 | 0.687 |

With the establishment of the location of the nappe underside with respect to the sharp-crested weir at the maximum design overflow, optimum placement of filter members 22 can be established. Optimum placement of a first filter array 21a will be as close to the weir as possible while allowing larger objects, such as bottles and cans, to pass down into the holding chamber. This allows the overflow to pass through the filter array at a sub-critical velocity wherein the profile of the overflow nappe is not disturbed.

For the Q₁ overflow discussed above, optimum placement of a first filter array 21a is 0.1 m from the weir 16 with the bottom of the first array needs to only be slightly below the top of weir 16 (although it may be longer if desired). A second filter array 21b is calculated to be placed parallel, and staggered for maximum effect, from the first array 21a at a spacing of about 0.025 m from the first array. The second array 21b is longer than the first because the nappe at the second array will be downstream from the first array and therefore vertically lower (see FIG. 4). Further filter arrays may be placed downstream from the second array and in a position to ensure maximum nappe flow therethrough. The further filter arrays may extend below the level of the top of retention screen 38.

FIG. 2 is a side sectional view with the sewer overflow chamber 12 to the left-hand side and the solids separator 10 to the right-hand side of the Figure. Normally sewage passes through the sewer overflow chamber on its way to the treatment plant but during high flows, above the capacity of sewer outlet pipe 14, sewage is discharged to the separator via the sharp-crested weir 16 of the separator located adjacent to the sewer overflow chamber 12. This discharge contains highly objectionable matter that is damaging to the environment.

As mentioned above, the use of perforated screens to separate solids from the water has proven unsatisfactory as the perforations easily block due mainly to the sticky nature of sewage solids. The filter means of the present solids separator 10 does not suffer the same problems.

As illustrated in FIGS. 1 to 6, the two rows of wire arrays 21 function to filter all solids from the overflowing nappe by trapping the solids between the ‘teeth’ of the comb arrays and allowing the solids to drop into holding chamber 40 under gravity, and under the weight of the water overflowing over the solids. The number and relative position of the arrays 21 may vary as discussed above to achieve an optimum filter.

FIG. 2 illustrates the normal dry weather water flow WL through the sewer overflow chamber 12. Ball valve 50 is open under the weight of the ball 52 in the ball chamber 53, which is dry.

In FIG. 3 the water level WL entrained with sewer solids S rises in the overflow chamber 12 towards baffle 17. Ball valve 50 has now closed.

In FIG. 4 the water level WL has risen to a point where it is overflowing weir 16 and the nappe N created by the overflow passes through the arrays 21 of filter members, which thereby ‘comb’ the nappe of solids allowing the nappe to fall into the filtered water chamber 42 clean of all solids.

On passing through the wire arrays a small portion of the nappe N is also captured together with the sewer solids S. That captured water drops down into the holding chamber 40 carrying solids with it. A small flow created by the captured water then passes through the retention screen 38 to the filtered-water chamber 42 but at such low velocities that the solids are retained and tend not to adhere to the retention screen 38. Furthermore, the impact of the overflowing water into the filtered-water chamber generates turbulence that also assists in maintaining the screen free of solids.

The horizontal distance the nappe N projects before impacting on the water surface of the filtered-water chamber 42 can determine the length of the separator. The depth of overflow on the exit weir 36 determines the surface level elevation. In the above example of a once-in-five-year overflow Q₅ of 0.333 m³/m/s, an overall separator length L of 0.500 m is required. If this length is not practical the nappe may be allowed to discharge above the exit weir and directly to the overflow outlet 15.

The height of the retention screen 38 is dictated by both the water surface level elevation during the once-in-five-year overflow Q₅ to retain captured solids, and by the profile of the once in a year overflow Q₁ design, as it is preferred that the Q₁ nappe passes over screen 38 and minimise adherence of solids to retention screen 38. The height of retention screen 38 in this example is calculated to be a maximum of 0.460 m above the floor, which is a height higher than the surface water level during the once-in-five-year overflow.

Lesser overflows than the design Q₁ flow will generally pass through the wire arrays but impact on the retention screen or water surface of the holding chamber. The top the retention screen is rounded to minimize sewer solid adherence. The flows below the water surface pass through the retention screen for these lesser flows at non-adhering velocities.

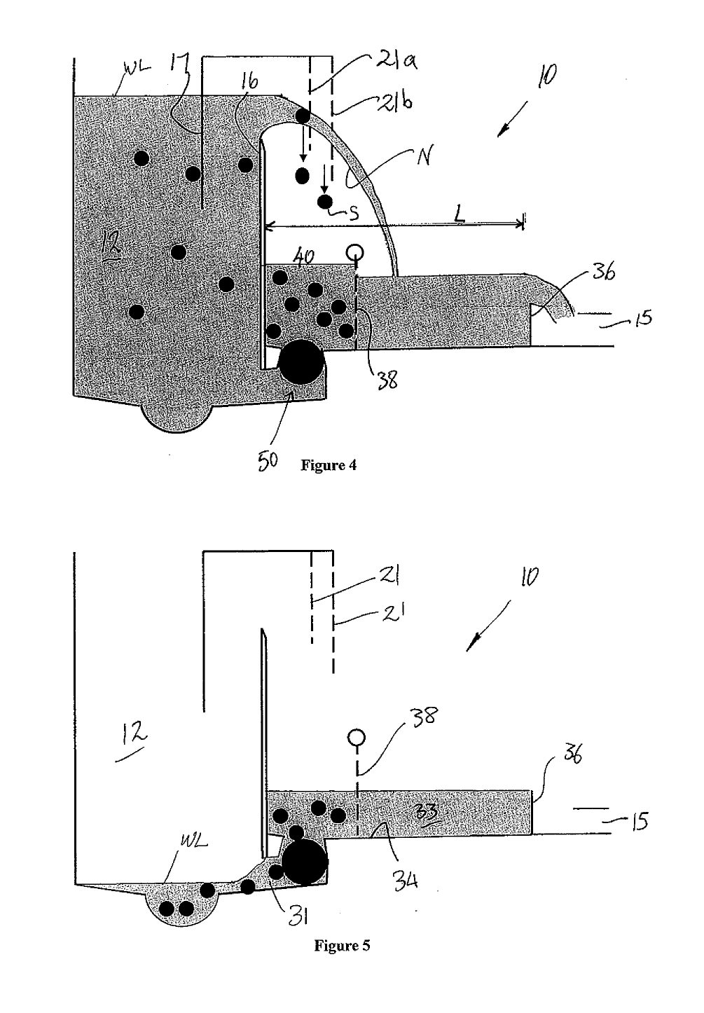

When the overflow event ceases and the water level in the sewer falls as illustrated in FIG. 5, the ball valve opens and the sewer solids are flushed back to the sewer. The flush-water in reserve in the filtered water chamber 42 passes back through the retention screen to assist in flushing solids from the screens back to the sewer.

The present solids separator is an improvement on previous separators having a far more effective means of separating sewer solids from sewage overflows while avoiding blockage of the filter means as well as the screen in the liquid return system. The separator 10 is economical to manufacture as the means of screening solids and the general arrangement of the separator considerably reduces the quantity of stainless steel required in its manufacture.

The present solids separator is capable of separating the sewer solids from the overflow over the entire range of overflows, namely from regular overflows, sub-critical to super-critical flows, and to once in five year overflows, and more. In contrast, all other types of separators that bypass overflows often fail to cope with higher flow rates. This is achieved because the array of vertical filter members intercepts all overflows into the separation chamber, regardless of flow rate.

The separator is also more compact and can therefore fit into tighter spaces. This is because known solids separator designs rely on gravity to separate the solids from the liquid. The present design can yield a shorter separator as solid separation does not rely on gravity alone but rather the solids are intercepted by the filter members and redirected vertically downward into the holding chamber under the flowing force of the overflowing water as well as some gravitational drop.

Many modifications of this embodiment of the invention will be apparent to those skilled in the art without departing from the spirit and scope of the invention.

1.-19. (canceled)

20. A solids separator for use in a sewer overflow chamber having an inlet, flow chamber and main outlet, whereby liquid, having solids entrained therein, flows from the inlet through the flow chamber to the outlet, the solids separator comprising:
an overflow weir over which liquid flows during overflow into a separation chamber;
a filter in the separation chamber that filters solids and allows liquid to pass through to an overflow outlet; and
a return outlet through which filtered solids return back into the flow chamber, wherein the filter includes an array of vertical filter members spaced from a top of the overflow weir such that a liquid flowing over the weir passes through the filter members.

21. The solids separator as claimed in claim 20, wherein the filter members are substantially rigid and span along the length of the weir.

22. The solids separator as claimed in claim 20, wherein the filter members hang downwardly from a ceiling of the solids separator to at least the height of the overflow weir.

23. The solids separator as claimed in claim 20, wherein the filter members are separated by a distance of 5 mm to 25 mm to each adjacent filter member.

24. The solids separator as claimed in claim 20, wherein the filter includes a second array of vertical filter members spaced from the first array further from the overflow weir.

25. The solids separator as claimed in claim 24, wherein the second array is arranged to be staggered from the first array.

26. The solids separator as claimed in claim 24, wherein the second array hangs lower from a ceiling of the separator than the first array.

27. The solids separator as claimed in claim 20, wherein the filter members are wires having a diameter of approximately 1 mm to 5 mm.

28. The solids separator as claimed in claim 25, wherein the effective spacing between the filter members across three arrays is approximately 4.5 mm.

29. The solids separator as claimed in claim 24, wherein the filter includes a third array of vertical filter members spaced from the second array still further from the overflow weir in staggered formation with respect to the first and second arrays.

30. The solids separator as claimed in claim 20, wherein the separation chamber includes a solids holding chamber locating below the filter into which filtered solids are retained then returned back into the flow chamber.

31. The solids separator as claimed in claim 30, including a return system containing a filtered liquid reserve for collecting and holding filtered liquid that then flows into the solids holding chamber and flushes filtered solids back into the flow chamber through the return outlet.

32. The solids separator as claimed in claim 31, wherein a retention screen separates the filtered liquid reserve from the solids holding chamber.

33. The solids separator as claimed in claim 32, wherein the retention screen is a perforated screen, a mesh, an array of wires or a bar screen.

34. The solids separator as claimed in claim 20, including a ball valve at the return outlet to stop flow therethrough from the flow chamber to the solids holding chamber.

35. The solids separator as claimed in claim 20, including a damper in the flow chamber spaced from an upper end of the overflow weir at a distance for regulating the size of solids entering the separation chamber.

36. A method of separating solids from liquid in a sewer overflow chamber having an inlet, flow chamber and main outlet, including:
directing an overflow over an overflow weir and into a separation chamber;
filtering solids through a filter in the separation chamber comprising an array of vertical filter members spaced from a top of the overflow weir, by intercepting all liquid overflowing into the separation chamber and passing the liquid through to an overflow outlet while filtering solids into a holding chamber located below the filter; and
returning filtered solids back into the flow chamber.

37. The method as claimed in claim 36, including filtering solids in a sub-critical and super-critical overflow.

38. The method as claimed in claim 36, including retaining a portion of filtered liquid in reserve for flushing filtered solids back into the flow chamber.
